(19) United States
(12) Patent Application Publication
(10) Pub. No.: US 2015/0177002 A1
(43) Pub. Date: Jun. 25, 2015

(54) METHOD AND SYSTEM FOR GENERATING A PARKING AREAS MAP BASED ON SIGNALS FROM PERSONAL COMMUNICATION DEVICES INDICATIVE OF PARKING EVENTS

(71) Applicant: MOBYDOM Ltd., Kadima (IL)

(72) Inventors: Naji SOURANI, Herzlia (IL); Zion HAREL, Kadima (IL)

(73) Assignee: MOBYDOM Ltd., Kadima (IL)

(21) Appl. No.: 14/139,886

(22) Filed: Dec. 24, 2013

(51) Int. Cl. G01C 21/26

(52) U.S. Cl. CPC G01C 21/26

(57) ABSTRACT

A system and method of generating a parking areas map from signals gathered from users of pay by phone parking service is provided herein. The steps of a method may include: obtaining, from a plurality of personal communication devices, signals indicative of events which represent cars being parked at designated parking spaces; deriving a geographical location which corresponds with each one of the designated parking spaces; obtaining a street map which covers an area of interest which includes at least some of the designated parking spaces; applying an event processing function to the parked car events, the corresponding geographical locations and the street map, to yield tempo spatial data that associated events of parked cars and the street map; generating a parking areas map indicating all parking areas geographically marked on the steer map, based on the tempo spatial data.

### FIELD OF THE INVENTION

The present invention relates generally to the field of geographic information systems (GIS) combined with crowd sourcing and in particular to event processing of parking events for generating parking areas maps.

### BACKGROUND OF THE INVENTION

Prior to setting forth a short discussion of the related art, it may be helpful to set forth definitions of certain terms that will be used hereinafter.

The term “pay-by-phone parking” as used herein, is defined as any computerized service implemented via a combination of software and hardware that allows a driver parking in a fare required space the option to divert the expense to a credit card via the use of a mobile phone, mobile application, personal communication device or any computer. Pay-by-phone parking provides an alternative to inserting change, notes or banknotes into a parking meter or pay and display machine.

The term “information system” or “GIS” as used herein, relates to a system designed to capture, store, manipulate, analyze, manage, and present all types of geographical data. In some implementation, GIS is the merging of cartography, statistical analysis, and computer science technology. A GIS digitally makes and “manipulates” spatial areas that may be jurisdictional, purpose, or application-oriented.

The term “event processing” as used herein, is defined as a method of tracking and analyzing (processing) streams of information (data) about things that happen (events), and deriving a conclusion from them. Complex event processing, or CEP, is event processing that combines data from multiple sources to infer events or patterns that suggest more complicated circumstances.

The look for available parking space is a never ending challenge specifically in large city centers. Many attempts were made to facilitate the process of locating available parking spaces in real time as well as enabling alternative means of payment, the pay by phone with its different variations being the most successful to date.

However, a rather neglected challenge that was not sufficiently addressed to date is how to collect valid and updated data regarding the actual location of the parking areas within a specified geographical location such as a city center. Parking areas may be either public or private and their accurate location and shape, capacity, pricing policy, operating hours and other parameters tend to change over time.

It would be therefore advantageous, for organizations such as city councils and municipal parking committees to be able to receive as much as accurate geographical data indicating the location, shape and other data relating to parking areas within their town or city.

### BRIEF SUMMARY OF THE INVENTION

The challenge of generating an accurate parking areas map for a town or a city is met, in accordance with embodiments of the present invention by applying event processing approach combined with crowd sourcing of pay by phone parking service users, to yield a GIS parking areas map.

Embodiments of the present invention provides an event processor configured to: obtain, from a plurality of personal communication devices, signals indicative of events which represent cars being parked at designated parking spaces; derive a geographical location which corresponds with each one of the designated parking spaces; obtain a street map which covers an area of interest which includes at least some of the designated parking spaces; and apply an event processing function to the parked car events, the corresponding geographical locations and the street map, to yield tempo spatial data that associated events of parked cars and the street map; and a parking areas generator configured to generate a parking areas map indicating all parking areas geographically marked on the steer map, based on the tempo spatial data.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 a block diagram illustrating an environment of a system according to some embodiments of the present invention;

FIG. 2 a block diagram illustrating the architecture of a system according to some embodiments of the present invention; and

FIG. 3 a high level flowchart diagram illustrating a method according to some embodiments of the present invention.

The drawings together with the following detailed description make the embodiments of the invention apparent to those skilled in the art.

### DETAILED DESCRIPTION OF THE INVENTION

It is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

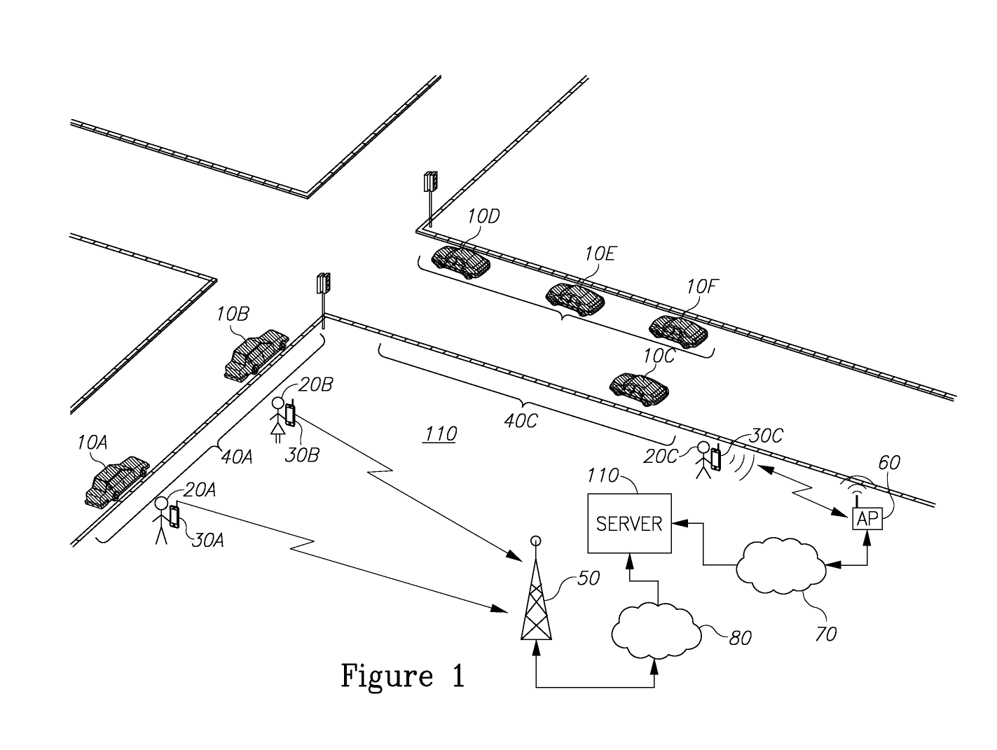

FIG. 1 a block diagram illustrating an environment of a system according to some embodiments of the present invention. The scene shows a street crossing with designated parking areas 40A-40C each including a few parking spaces. Some of the parking spaces within these parking areas are occupied by cars 10A and 10B, 10D, 10E, 10F, 10C some of which may be associated drivers 20A, 20B or 20C who have a personal communication device 30A, 30B or 30C respectively that may be subscribed with a pay by phone parking service. Once a driver parks his or her car, he or she used the personal communication device to issue a signal initiating a parking. The signal is conveyed to a server 110 via a base station 50 in a case of cellular communication or an access point (AP) 60 in a case of Wi-Fi communication. The signals may be conveyed to server 110 via corresponding networks 70 and 80, where they are being processed.

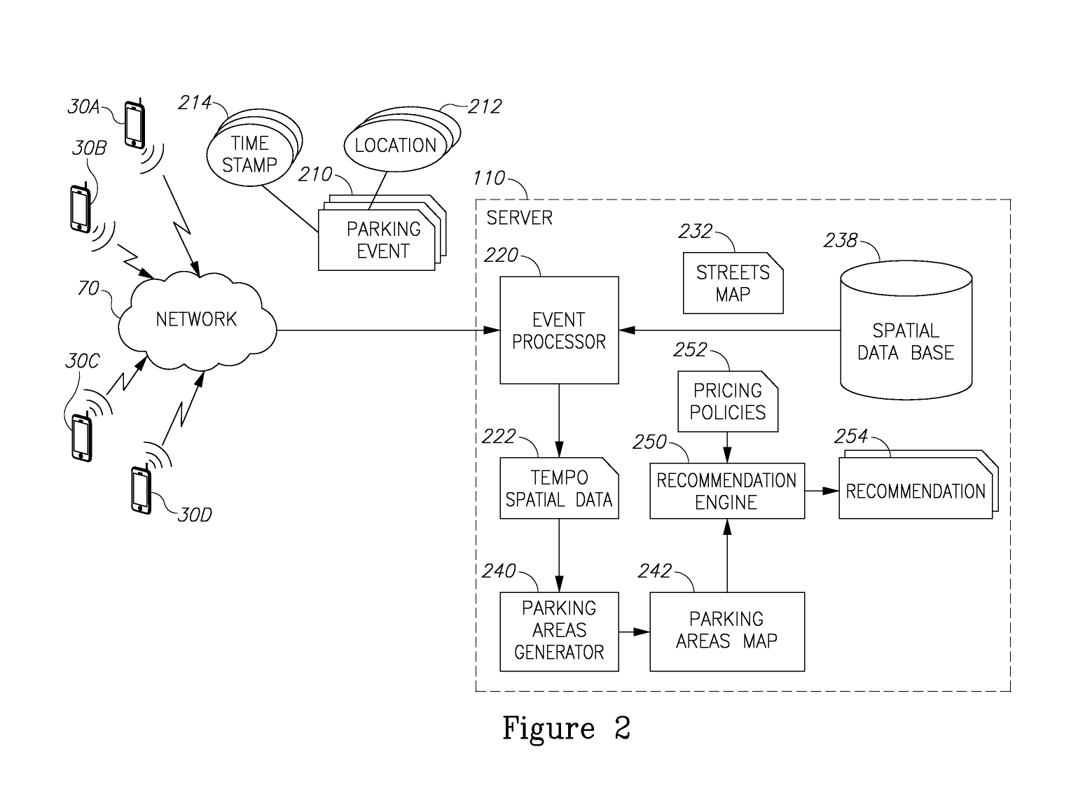

FIG. 2 a block diagram illustrating the architecture of a system according to some embodiments of the present invention. The system may include a server 110 in communication with a plurality of personal communication devices 30A-30D over a network (e.g. internet, cellular communication network). Personal communication devices 30A-30D is associated with a user (driver) who in turn is associated with a car that is being parked.

Server 110 may include an event processor 220 configured to: obtain, from plurality of personal communication devices 30A-30D, signals indicative of parking events 210 which represent cars being parked at designated parking spaces. Specifically, each one of parking events 210 may be associated with a geographical location 212 of the parked car, and possibly with a time stamp 214 indicative of at least a starting time of the parking event 210.

Event processor 220 may further be configured to derive a geographical location which corresponds with each one of the designated parking spaces. Additionally, event processor 220 may obtain a street map which covers an area of interest which includes at least some of the designated parking spaces. Then, event processor 220 may apply an event processing function to the parked car events, the corresponding geographical locations and street map 232, to yield tempo spatial data 222 that associated events of parked cars and the street map.

Server 110 may include a parking areas generator 240 configured to generate a parking areas map 242 indicating all parking areas geographically marked on the steer map, based on the tempo spatial data 222.

According to some embodiments, server 110 may further include a recommendation engine 250 configured to receive pricing policy and apply a recommendation function to the parking areas map, to yield recommendations 254 such as price-optimization of the parking areas, based on the pricing policy.

According to some embodiments, event processor 220 may be further configured to repeat the obtaining of the signals indicative of the parking events and the applying of the event processing thereto, over time, and the parking areas generator is configured to repeat the generating over time, to yield an updated parking areas map.

According to some embodiments, personal communication devices 30A-30D may be subscribed with a pay by phone parking service. The signals transmitted by the personal communication devices 30A-30D are indicative of the parking events provide at least a start time of the parking event.

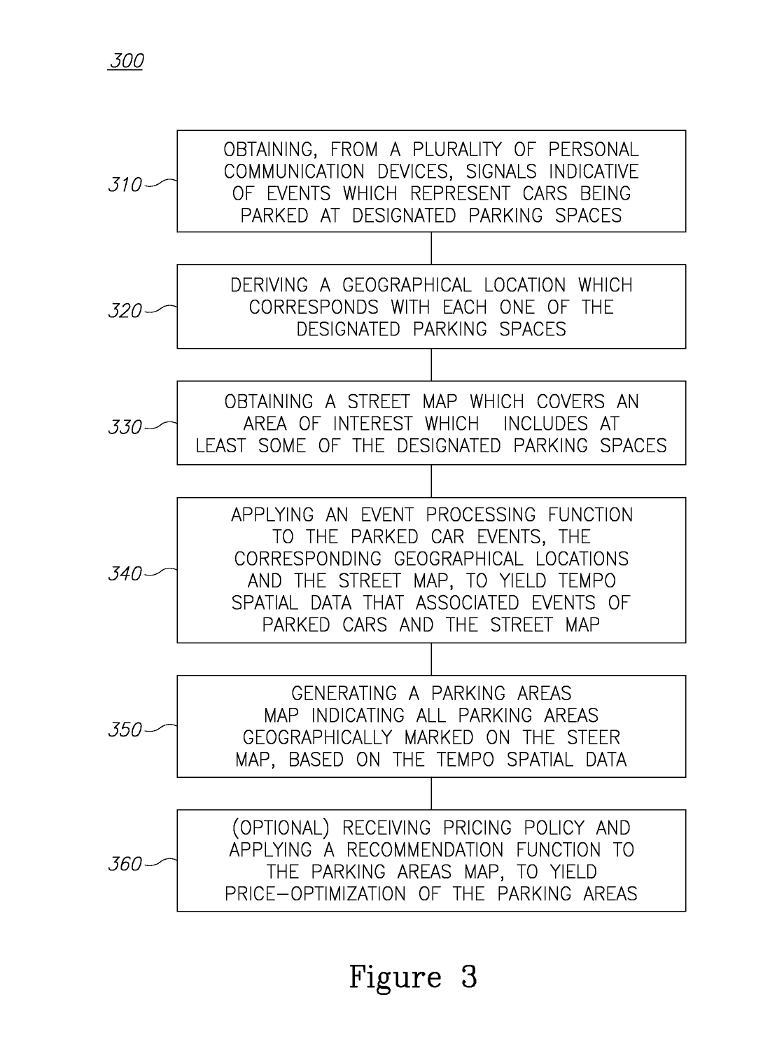

FIG. 3 a high level flowchart diagram illustrating a method 300 according to some embodiments of the present invention. It should be understood that method 300 may be implemented by any architecture and should not be limited to the aforementioned architecture of server 110. In some embodiments, method 300 may include the following stages: obtaining, from a plurality of personal communication devices, signals indicative of events which represent cars being parked at designated parking spaces 310; deriving a geographical location which corresponds with each one of the designated parking spaces 320; obtaining a street map which covers an area of interest which includes at least some of the designated parking spaces 330; applying an event processing function to the parked car events, the corresponding geographical locations and the street map, to yield tempo spatial data that associated events of parked cars and the street map 340; and generating a parking areas map indicating all parking areas geographically marked on the steer map, based on the tempo spatial data 350.

According to some embodiments of the present invention, method 300 may further include the step of receiving pricing policy and applying a recommendation function to the parking areas map, to yield price-optimization of the parking areas, based on the pricing policy 360.

According to some embodiments of the present invention, method 300 may further include the step of comprising repeating the obtaining of the signals indicative of the parking events and the applying of the event processing thereto, over time, to yield an updated parking areas map.

According to some embodiments of the present invention, the personal communication devices may be subscribed with a specified pay by phone parking service.

According to some embodiments of the present invention, the geographical location may be derived from a global positioning system (GPS) associated with the personal communication devices. Alternatively, the geographical location may be derived from a base station or an access point associated with the personal communication devices.

According to some embodiments of the present invention, the signals indicative of the parking events may provide at least a start time of the parking event.

According to some embodiments of the present invention, the signals indicative of the parking events further provide an end time of the parking event, and wherein the start time and end time are further used for determining parking duration density per parking area.

According to some embodiments of the present invention, method 300 may further include the step of comprising applying a recommendation function to the parking areas map, to yield price-optimization of the parking areas, based on the parking duration density.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
obtaining, from a plurality of personal communication devices, signals indicative of events which represent cars being parked at designated parking spaces;
deriving a geographical location which corresponds with each one of the designated parking spaces;
obtaining a street map which covers an area of interest which includes at least some of the designated parking spaces;
applying an event processing function to the parked car events, the corresponding geographical locations and the street map, to yield tempo spatial data that associated events of parked cars and the street map; and
generating a parking areas map indicating all parking areas geographically marked on the steer map, based on the tempo spatial data.

2. The method according to claim 1, further comprising receiving pricing policy and applying a recommendation function to the parking areas map, to yield price-optimization of the parking areas, based on the pricing policy.

3. The method according to claim 1, further comprising repeating the obtaining of the signals indicative of the parking events and the applying of the event processing thereto, over time, to yield an updated parking areas map.

4. The method according to claim 1, wherein the personal communication devices are subscribed with a pay by phone parking service.

5. The method according to claim 1, wherein the geographical location is derived from a global positioning system (GPS) associated with the personal communication devices.

6. The method according to claim 1, wherein the geographical location is derived from a base station or an access point associated with the personal communication devices.

7. The method according to claim 1, wherein the signals indicative of the parking events provide at least a start time of the parking event.

8. The method according to claim 7, wherein the signals indicative of the parking events further provide an end time of the parking event, and wherein the start time and end time are further used for determining parking duration density per parking area.

9. The method according to claim 8, further comprising applying a recommendation function to the parking areas map, to yield price-optimization of the parking areas, based on the parking duration density.

10. A system comprising:
an event processor configured to:
obtain, from a plurality of personal communication devices, signals indicative of events which represent cars being parked at designated parking spaces;
derive a geographical location which corresponds with each one of the designated parking spaces;
obtain a street map which covers an area of interest which includes at least some of the designated parking spaces; and
apply an event processing function to the parked car events, the corresponding geographical locations and the street map, to yield tempo spatial data that associated events of parked cars and the street map; and
a parking areas generator configured to generate a parking areas map indicating all parking areas geographically marked on the steer map, based on the tempo spatial data.

11. The system according to claim 10, further comprising a recommendation engine configured to receive pricing policy and apply a recommendation function to the parking areas map, to yield price-optimization of the parking areas, based on the pricing policy.

12. The system according to claim 10, wherein the event processor is further configured to repeat the obtaining of the signals indicative of the parking events and the applying of the event processing thereto, over time, and the parking areas generator is configured to repeat the generating over time, to yield an updated parking areas map.

13. The system according to claim 10, wherein the personal communication devices are subscribed with a pay by phone parking service.

14. The system according to claim 10, wherein the geographical location is derived from a global positioning system (GPS) associated with the personal communication devices.

15. The system according to claim 10, wherein the geographical location is derived from a base station or an access point associated with the personal communication devices.

16. The system according to claim 10, wherein the signals indicative of the parking events provide at least a start time of the parking event.

17. The system according to claim 16, wherein the signals indicative of the parking events further provide an end time of the parking event, and wherein the start time and end time are further used for determining parking duration density per parking area.

18. The system according to claim 17, further comprising applying a recommendation function to the parking areas map, to yield price-optimization of the parking areas, based on the parking duration density.
